(19) United States
(12) Patent Application Publication
(10) Pub. No.: US 2024/0241017 A1
(43) Pub. Date: Jul. 18, 2024

(54) IN SITU SOIL GAS PROBES AND SAMPLING SYSTEMS

(71) Applicant: ARIZONA BOARD OF REGENTS ON BEHALF OF THE UNIVERSITY OF ARIZONA, Tucson, AZ (US)

(72) Inventors: Laura Meredith, Tucson, AZ (US); Peter Moma, Tucson, AZ (US); Till Volkmann, Tucson, AZ (US)

(21) Appl. No.: 18/559,948

(22) PCT Filed: May 12, 2022
(86) PCT No.: PCT/US22/28964

§ 371 Date: Nov. 9, 2023

Related U.S. Application Data
(60) Provisional application No. 63/187,527, filed on May 12, 2021.

(51) Int. Cl. G01N 1/22

(52) U.S. Cl. CPC G01N 1/2294; G01N 2001/2285

(57) ABSTRACT

The disclosure includes a soil gas sampling probe for collection samples of soil gas, a soil gas sampling system that includes at least one recirculation loop that includes a soil gas sampling probe as a component, and methods of using the soil gas sampling probe and the soil gas sampling system.

### CROSS-REFERENCE TO RELATED APPLICATIONS

This application claims the benefit of Provisional Appl. No. 63/187,527, filed May 12, 2021. The content of the aforesaid application is relied upon and is incorporated by reference herein in its entirety.

### TECHNICAL FIELD

The present invention relates to soil gas probes, soil gas measuring systems that use such probes, and methods of measuring soil gases.

### BACKGROUND

The earth's atmosphere is vital to life, and is composed of various gases, some of which cause climate change and need to be controlled. Emission of these gases must be constrained, and the least constrained major reservoir the gases is soil. Soil gases are complicated to measure, and there is a need to have the capability to measure soil gases at several scales.

The composition of gas in soil is a powerful indicator of various important soil processes, including microbial activity, soil carbon stability, agricultural nitrogen efficiency, soil health, presence of beneficial or detrimental biological actors, status of contamination or bioremediation status. However, most technologies that are currently available to measure soil gases are invasive and disruptive to the soil due to their large size, which also causes lower resolution in measurement of soil gases. Additionally, current technologies for soil gas sampling and measurement generally require costly materials. There is a need for improvements in soil gas sampling technology that is compact, durable, accurate, and economic for use in the field.

The present invention offers significant improvements over the traditional soil gas probes.

### SUMMARY

The composition of gases in soil is a powerful indicator for important soil processes including, for example, microbial activity, soil carbon stability, agricultural nitrogen efficiency, soil health, presence of beneficial or detrimental biological actors, contamination or bioremediation status, and more. Yet, few technologies exist to measure soil gas composition in ways that are not destructive or disruptive and at high temporal and spatial scales that match the scale of important microbial processes. The invention provides a new soil gas probe and sampling system to meet these needs and advance soil monitoring across diverse applications.

One advantage of the invention is a compact soil gas probe design that is made from cost-effective material. Additionally, said probe is minimally invasive and disruptive given its small size. Furthermore, its small size additionally allows for high spatial resolution measurements of soil gas samples. This allows for an enhanced and more accurate representation of the concentration of gas in soil and may be configured to allow for automation for measuring soil gases online.

In one aspect, the invention encompasses a soil gas sampling probe. In some embodiments, the soil gas sampling probe has an internal volume of less than 5 cm³.

In another aspect, the invention includes a soil gas sampling system.

A further aspect of the invention of the invention pertains to a soil gas sampling system comprising a recirculation loop that comprises a soil gas sampling probe according to the invention, a volume expansion tube, a micropump, and a flowthrough valve. In some embodiments, the soil gas sampling system includes a plurality of recirculation loops.

In another aspect, the invention encompasses a method of measuring soil gas.

A further aspect of the invention pertains to a method of measuring soil gas comprising allowing a gas to diffuse into a soil gas sampling probe according to the invention.

The soil gas sampling technology of the invention is applicable in areas of soil health, agricultural monitoring, waste-water and pond systems, bioreactors (e.g., in food industry), gas well and other subsurface monitoring, bioremediation monitoring, carbon capture and sequestration monitoring, investigation of hydrogeological conditions, rock-water interaction and geochemical development, estimation of mass transport, (e.g., pollutants, origin of salinization and contamination processes), investigation of groundwater quality, irrigation mechanisms, and more broadly in ecosystem ecology, soil science, biogeochemistry, plant-microbe interactions, plant physiology, studies of ecosystems (e.g., plant water absorption), agricultural studies, and other environmental science research and monitoring.

### BRIEF DESCRIPTION OF THE DRAWINGS

FIG. 1A is a schematic perspective view of an exemplary soil gas sampling probe according to the invention.

FIG. 1B is a schematic cross-sectional side view of an exemplary soil gas probe according to the invention.

FIG. 2 is a diagram showing the flow of gas through components of an exemplary soil gas sampling system according to the invention.

FIG. 3 is a schematic showing an exemplary multiprobe sampling system according to the invention.

It is to be understood that the following detailed description is exemplary and explanatory only and is not restrictive of the invention, as claimed.

### DETAILED DESCRIPTION

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

### Definitions

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a ±10% variation from the nominal value. It is to be understood that such a variation is always included in any given value provided herein, whether or not specifically referred to.

As used herein, the term “advection” refers to transport of a substance by bulk motion of a fluid (e.g., a gas or a liquid), driven, for example, by a pressure gradient.

As used herein, the term “diffusion” refers to a net movement of a substance from a region of higher concentration to a region of lower concentration of the substance, via random motions. Diffusion is driven by a concentration gradient.

As used herein, the term “MFC” refers to a mass flow controller device used to measure and control the flow of liquids and gases.

As used herein, the term “probe” refers to a soil gas sampling probe.

The invention solves several challenges faced by current soil gas analyzing technologies. For example, in some embodiments it provides a compact soil sampling probe made from cost-effective material. Advantageously, the soil gas sampling probe according to the invention is less invasive than currently available technology, in part due to the relatively small scale of the device. Furthermore, the compact size of the soil gas sampling probe allows for higher spatial resolution measurements in comparison with other commonly used soil gas sampling probes. The soil gas sampling probe of the invention is useful in a system capable of providing an enhancement in accurate measurement of the concentration of gas in soil. Further, the soil gas system of the invention is user-friendly (for example, the system may be automated and allow online measuring of soil gases. Additionally, the use of a low-fluctuation micropump provides enhanced measurement stability in comparison with peristaltic pumps.

Furthermore, the invention provides significant improvements over traditional soil gas probes such as those described in DE10201313969B3 and DE202014003581. For example, in some embodiments, the invention provides a reduction in sampling footprint by a factor of 10 (e.g., ˜0.3 cm²) surface area. Without wishing to be limited by any particular theory, a smaller surface area for gas exchange across diffusive membrane than cylindrical designs ˜10-20 cm² for 10 cm long ¼″ OD tubing enables higher spatial resolution measurements and lower sampling artifacts.

In some embodiments, the invention advantageously provides a more accurate and representative of true soil gas concentrations by avoiding artifacts. In further embodiments the invention encompasses a smaller soil gas sampling membrane (e.g., about 0.3 cm²) more precisely shows activity at high spatial resolution in soil, without averaging normally disconnected areas in soil. These small sample volumes equilibrate, and re-equilibrate quickly with soil gas, allowing representative soil gas samples to be measured at higher frequency than with systems requiring a larger volume of sample gas. In some embodiments, the soil gas sampling of the invention permits measurement of gas concentrations (not just isotopic signature as in see in soil gas probes as described in DE10201313969B3 and DE202014003581).

In some embodiments, a system according to the invention uses a recirculating sampling approach to pre-equilibrate enough volume to measure. One advantage of this approach is that only a small volume of sample is required (cf. the flow-through sampling used on traditional methods such as used in DE10201313969B3 and DE202014003581). In further embodiments, the invention encompasses as a system comprising an expansion volume in the recirculating loop to increase total sample volume, while keeping the soil probe exchange membrane very small, e.g., the recirculating loops may contain their own mini pumps with very low pressure perturbation to prepare equilibrated soil gas sample for analysis (instead of having one pump withdrawing sample from the probe being measured). This produces a more equilibrated sample, in contrast with flow-through sampling methods described in DE10201313969B3 and DE202014003581.

One aspect of the invention pertains to a probe comprising a glass tube, stainless steel tubing and a sintered membrane (optionally with a hydrophobic coating). Conversely, traditional probes provide two separate chambers (see e.g., DE10201313969B3 and DE20201400358.

In some embodiments, the invention is a porous membrane comprising stainless steel with or without hydrophobic coating (to e.g., prevent passage of liquid water into probe). In contrast, the probes described in DE10201313969B3 and DE202014003581 use materials including polypropylene and polyethylene tubing.

Advantageously, probes according to the invention are more robust than traditional probes, such as those described in DE10201313969B3 and DE202014003581. This is due in part to its small and compact size and rigid materials such as glass or stainless steel. As a result, the probes of the present invention can, for example, be dropped or even thrown on the ground or compacted without breaking.

Another advantage of the invention is that the probes can be modified to integrate other sensors with the probe, such as a small pressure sensor by passing the sensor head alongside the stainless steel tubing into the probe chamber. This type of modification is not possible with traditional probes such as the ones in described in DE10201313969B3 and DE202014003581.

Yet another advantage of the invention is that probes according to the invention are less invasive and disruptive given their smaller size. Additionally, these probe are diffusive and not susceptible to advective soil gas sampling and in some embodiments involves use of a low-fluctuation micropump instead of peristaltic pumps or others described in DE10201313969B3 and DE202014003581 traditionally used in gas wells.

Advantageously, the present invention leverages the demand for small gas analyzer and includes innovations to increase the spatial and temporal resolution of representative soil gas sampling. The soil gas materials and system differ significantly from other traditional methods (see Gil-Loaiza et al., and Volkmann patent) that uses larger probes of different materials and flow-through online sampling to match the larger volume demand of laser spectrometers.

To make in-situ soil gas measurements at the high spatial resolution, one problem to solve is reducing the size of the probes used to sample soil gases. Conventional used soil gas sampling methods use high surface area probes made of a porous material, through which analyte-free air can pass and emerge fully equilibrated with soil gases (see, for example, Gil-Loaiza 2020). Dimensions of the sampling probes may be on the order of 15 cm long×2.5 cm outside diameter (OD) (120 cm² surface area, 75 mL volume). These methods can work well in sampling situations that have adequate space for these probes, or when large volumes of sample are required for filling a detector (e.g., a laser-based detector). However, such large probes are unsuitable for measurements which require a high degree of spatial resolution to monitor soil gas gradients around soil gas sources.

Soil gas collection levels can be measured using an online system with automated processes. A further aspect of the invention pertains to a soil gas sampling probe comprising a small sampling element (in some embodiments, about 0.625 cm in diameter) to measure soil gases e.g., at high resolution. Materials for the sampling element may include stainless steel, optionally coated with a hydrophobic material. A further aspect of the invention pertains to a sampling process which is diffuse and does not rely on advective soil gas sampling. Further, soil gas sampling probes according to the invention may include sensors, such as e.g., a pressure, a temperature, and/or a humidity microsensors disposed on an interior surface of the probe.

One of the main goals in constructing compact recirculating probes was to make them as small as possible for spatial resolution while still storing enough sample volume in a recirculating loop to permit analysis of an equilibrated sample (e.g., by gas chromatography). An additional goal was to make probes that are easy to construct and produce at scale, and to make them from materials that are inert to the gases being tested, as well as being resistant to breakage.

### Soil Gas Sampling Probe

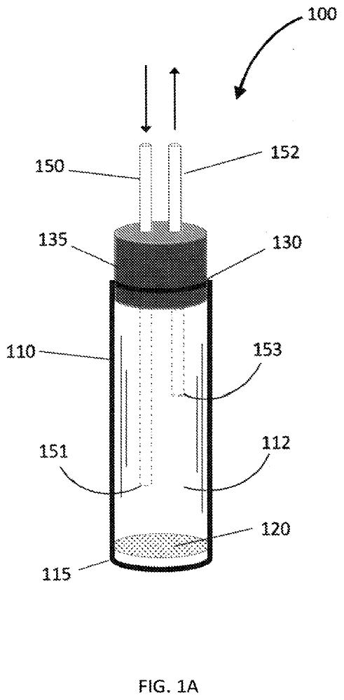

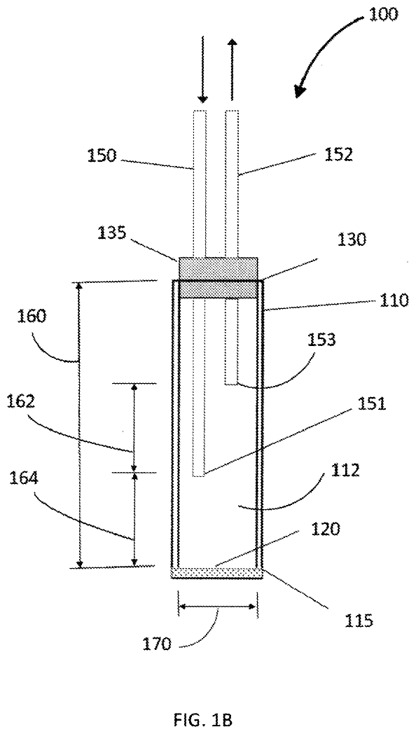

One aspect of the invention pertains to a soil gas sampling probe as outlined herein. For example, FIG. 1A shows a schematic perspective view of an exemplary embodiment of a soil gas sampling probe (“probe”) 100 according to the invention, and FIG. 1B shows a schematic cross-sectional side view of probe 100. Probe 100 comprises an elongated probe body 110 defining a hollow core 112 and an open end 115. A sintered element 120 is disposed at the open end 115. A first capillary tube 150 extends from outside of probe body 110 into hollow core 112, and a first capillary tube end portion 151 (shown with dashed lines) terminates within hollow core 112. Similarly, a second capillary tube 152 extends from outside of probe body 110 into hollow core 112, and a second capillary tube end portion 153 (shown with dashed lines) terminates within hollow core 112. In the embodiment shown, first and second capillary tubes 150 and 152 extend through a tube end 130 (with an optional seal material 135 (e.g., an epoxy adhesive), and first capillary tube end portion 151 terminates nearer sintered element 120 than does second capillary tube end portion 153.

FIG. 1B includes dimension arrows 160, 162, 164, and 170 to indicate overall dimensions (not to scale) of an embodiment of soil gas sampling probe 100, as well as the relative disposition of first capillary tube end portion 151 and second capillary tube end portion 153. In some embodiments, probe body 110 may have an overall length 160 of about 2.5 cm and a diameter 170 of about 0.63 cm (with a porous surface area of about 0.3 cm² and an internal volume of about 0.25 mL). In some embodiments, first capillary tube end 151 and second capillary tube end 153 are spaced apart along the length of probe body 110 by a distance 162 of about 1.25 cm. In some embodiments, first capillary tube end 151 is spaced apart from sintered element 120 by a distance 164 of about 0.5 cm. In some embodiments, dimensions 160, 162, 164, and 170 may be selected independently to obtain suitable embodiments of probe 100.ith a porous surface area of 0.3 cm² and an internal volume of 0.25 mL (respectively about 400× and 300× less than standard probes). This small volume reduces the impact of making measurements with a measuring system and improves the spatial resolution of the system.

In some embodiments, probe 110 comprises borosilicate glass or other suitable materials (e.g., materials inert to soil conditions).

In some embodiments, the probe body of the soil gas sampling probe has an overall length in a range of from 15 mm to 50 mm, from 20 mm to 40 mm, or even from 20 mm to 30 mm.

In some embodiments, the hollow core of the soil gas sampling probe has a volume of less than 5 cm³, less than 4 cm³, less than 3 cm³, less than 2 cm³, less than 1 cm³, less than 0.5 cm³, or even less than 0.3 cm³. In some embodiments, the hollow core of the soil gas sampling probe has a volume of at least 0.2 cm³, or even at least 0.25 cm³.

In some embodiments, the probe comprises a gas chromatograph tubing, a stainless steel sintered disk with a pore size of 10 micrometers, OD 110 and an adhesive (e.g., epoxy adhesive) to seal the components together. For example, 1/16 inch (1.6 mm) gas chromatograph tubing, a 0.25 inch (6.4 mm) OD stainless steel sintered disk with a pore size of 10 micrometers, a 0.25 inch (6.4 mm) by 0.16 inch (4.1 mm) OD 110 and an adhesive (e.g., epoxy adhesive) to seal the components together.

One advantage of the invention is that the outer casing (e.g., glass) is easy to obtain and work with, is nonreactive with gases, and makes assembly easier because components can be visually aligned. The stainless steel sintered disk may be obtained in a variety of pore sizes if equilibrium rate needs to be adjusted, is significantly more compatible with adhesives than polytetrafluoroethylene (the other main material used for sintered filters), and is inert or can be coated to improve the inert properties if needed. A hydrophobic coating may include, for example, a fluorinated material.

In some embodiments, the sintered element may have a pore size in a range of from 2 micrometers to 40 micrometers, from 2 micrometers to 20 micrometers, from or even from 5 micrometers to 15 micrometers. In an embodiment, the sintered element may have a pore size of about 10 micrometers.

In some embodiments, the sintered element is a disc having a diameter in a range of from 5 mm to 250 mm, from 5 mm to 200 mm, from 5 mm to 100 mm, from 5 mm to 50 mm, from 5 mm to 20 mm, or even from 5 mm to 10 mm. In an embodiment, the sintered element has a diameter of about 6 mm.

For securing the sintered element to the probe body, an adhesive may be used (e.g., an epoxy adhesive may be used, due to its low outgassing (as determined by NASA's testing protocol: https://outgassing.nasa.gov/), as well as its relatively long work time, wide availability, and strength).

In exemplary embodiment, the probe was assembled by horizontally inserting and positioning the two 6 inch (15 cm) sections of cleaned gas chromatograph (“GC”) tubing inside the glass tube and creating a top seal of epoxy, letting the adhesive cure for one day before reorienting the probe with the sintered filter end up, and applying epoxy and the sintered disk, and letting this cure for one day. A series of preliminary tests revealed that the epoxy did not emit H₂ gas during the construction or curing process. Therefore, the wait time required was only to ensure a high-strength seal. These probes were also strength tested and could be dropped or pulled on with significant force and did not break, making these probes very compatible with field installation into soils.

In some embodiments, the soil gas sampling probe according to the invention includes a sensor (including microsensors), for example, a pressure sensor, a humidity sensor, or a temperature sensor. The sensor(s) may be disposed within hollow core 112, optionally having electrical leads running through a probe end 130. Probe end 130 may optionally be a defined opening sealed with a seal material 135 (e.g., an epoxy adhesive) that can hold capillary tubes and electrical leads in place.

A further aspect pertains to a soil gas probe that is reusable. For example, the soil gas probe may be installed in place for a defined period (e.g., a short-term application of 24 hours). The probe in some embodiments may be placed in soil and remain there for extended periods (e.g., weeks or months), or even permanently. For example, the soil gas probe may be mounted in a pipe extending into soil, or even in concrete for a permanent application.

### Soil Gas Sampling System

Another aspect of the invention pertains to a soil gas sampling system, wherein said system comprises a recirculation loop which may further include a micropump and a valve for recirculating gas samples through said soil gas sampling probe.

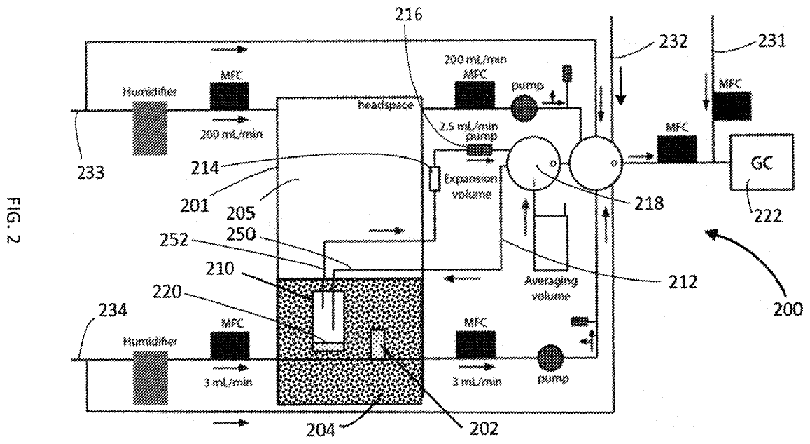

Another aspect of the invention pertains to a soil gas sampling system according to FIG. 2. In particular, FIG. 2 shows a schematic diagram for an exemplary embodiment of a soil gas sampling system 200 according to the invention. A controlled measurement chamber 201 contains a soil sample 204, a headspace 205, and a soil gas sampling probe (“probe”) 210. Probe 210 comprises a sintered element 220 (analogous to sintered element 120 in FIG. 1) and is shown disposed within soil sample 204, and proximate to a gas point source 202. A recirculation loop 212 includes several elements connected in series, including probe 210, expansion volume tube 214, a “micropump 216 (a flow rate of 2.5 mL/min is shown; in some other embodiments, the flow rate through the micropump may be selected to be another suitable flow rate), and flow-through valve 218. Micropump 216 continuously pumps a unidirectional flow of gas through recirculation loop 212, with flow direction indicated by arrows. A suitable micropump for the soil gas sampling system has a low level of pressure fluctuations. The pressure fluctuations are generally lower than what is delivered by a peristaltic pump (additionally, peristaltic pump may wear out more quickly). In some embodiments, the micropump selected for the soil gas sampling system generates a pulseless flow. In some implementations, the micropump may need to run continuously for weeks. Examples of suitable micropumps can be obtained from BARTELS-MIKROTECHNIK, Dortmund, Germany.

In the configuration shown in FIG. 2, flow-through valve 218 is also connected to gas chromatograph 222. Samples of gas in recirculation loop 212 can be diverted by flow-through valve 218 for injection into gas chromatograph 222 for analysis.

The elements in recirculation loop 212 are connected via tubing, preferably capillary tubing of a type commonly used with gas chromatography instruments. In some embodiments, the capillary tubing has an inside diameter of less than 2 micrometers, less than 1 micrometer, or even less than 0.8 micrometer. In further embodiments, the capillary tubing is stainless steel.

In FIG. 2, several gas lines 231, 232, 233, and 234 supply gases for system 200. In some embodiments, gas line 231 may supply calibration gases, with 0 ppm of H₂ gas; gas line 232 may supply 50 ppm H₂; gas line 233 may supply 0.5 ppm H₂; and gas line 234 may supply 5000 ppm H₂. In some other embodiments, other suitable ppm values for H₂ gas may be selected. In the system configuration shown, gas line 234 supplies point source 202 with a sample of H₂ gas that flows into soil 204 to provide a soil gas sample, and the soil gas sample diffuses into nearby probe 210 via a sintered element. In a flow pattern through recirculation loop 212, the soil gas sample that diffused into probe 210 is carried by a gas flowing through probe 210 from capillary tube 250 to capillary tube 252, from whence it flows through expansion volume tube 214 (typically a section of tubing with an inside diameter larger than the rest of the loop), through micropump 216, then through flow-through valve 218, and back to probe 210 via capillary tube 250. The expansion volume tube 214 may be included, e.g., increase the overall volume of the recirculation loop for holding a soil gas sample.

Also shown in FIG. 2 is the connection of point source 202 to a source of system gas, a humidifier, and a mass flow controller (“MFC”) that can act as a sample injector and control the air flow.

One aspect of the soil gas sampling system is its compact form factor, relative to other systems commonly in use. While a reduction in sampling probe volume results in a reduced amount of sample, gas chromatography can still provide high quality measurements of using only 50 microliters of a soil gas sample.

It is sometimes desirable to collect soil gas samples from a plurality of soil locations (e.g., 4 locations), typically positioned near each other. One of the reasons for this type of “parallel” sampling is to achieve a resolution of where the soil gas is located. While one soil gas sample can provide useful information about the identity and concentration of the soil gas, using multiple probes can provide a higher resolution of where the soil gases are located.

A gas chromatograph can sometimes require several minutes (e.g., 4 minutes) to process a single soil gas sample. In some embodiments, the invention encompasses a system, wherein said system is configured to include more than one soil sample probes (e.g., each within its own recirculation loop) connected to a multichannel valve that feeds samples sequentially into a gas chromatograph. In further embodiments, the system may be configured to keep multiple soil gas samples in a holding pattern, each awaiting its turn for injection into the gas chromatograph. The system may be further configured so that the individual soil gas samples is recirculated through their own respective recirculation loops. The system may be further configured so the soil gas sample is be recirculated at a rate that balances probe sensitivity to changes (high equilibration rate) and signal stability (low equilibration rate).

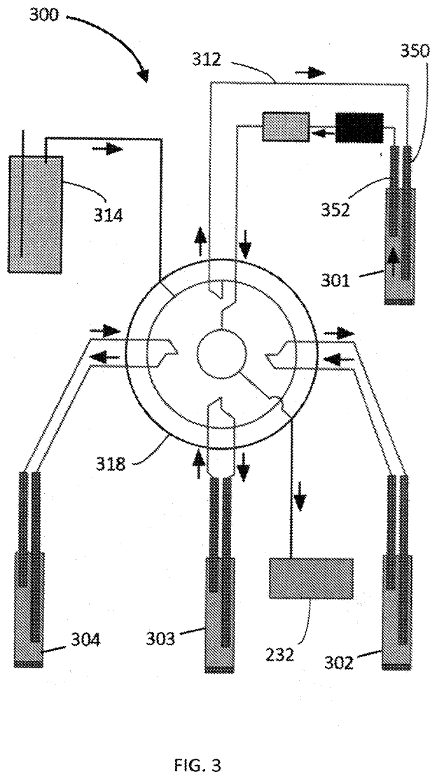

Another aspect of the invention pertains to a soil gas sampling system according to FIG. 3. In particular, FIG. 3 shows a simplified schematic diagram of an exemplary soil gas sampling system 300 that includes four soil gas sampling probes 301, 302, 303, 304 each connected to a multichannel flow-through valve 318. A recirculation loop 312 includes probe 301, expansion volume tube 314, micropump 316, multichannel flow-through valve 318, as well as capillary tubes 350 and 352, analogous to the system configuration shown in FIG. 2. Arrows indicate the direction of gas flow in the system. It will be understood that each of the other probes 302, 303, 304 include their own recirculation loop connected to the multichannel flow-through pump, including an expansion volume and micropump (not shown).

Multichannel flow-through valve 318 can optionally be operated under microprocessor control to select a particular recirculation loop for injection of a soil gas sample into gas chromatograph 322. In the configuration shown in FIG. 3, multichannel flow-through valve 318 is set in a position to direct a sample from recirculation loop 312 to gas chromatograph 322 for GC analysis.

### Methods for Sampling and Analyzing Soil Gases

Another aspect of the invention pertains to a method for sampling and analyzing soil gases. In one exemplary embodiment, the method includes exposing a soil gas sampling probe for a period of time to a soil that contains a soil gas (or not), where the probe is part of a soil gas sampling system according to the invention. If a soil gas is present, it diffuses into the probe through its sintered element and then is pumped through a recirculation loop, and ultimately is injected into a gas chromatograph for analysis. Typically, it is desirable to allow sufficient time for the soil gas sample to equilibrate through the circulation loop, including the expansion volume tube.

In some embodiments, the method sampling and analyzing soil gases includes using a sampling system with multiple probes, as described for soil gas sampling system 300.

### Embodiments

A non-limiting list of embodiments is provided below:

Embodiment 1. A soil gas sampling probe, comprising:
an elongated probe body defining a hollow core and an open end;
a sintered element disposed at the open end of the probe body;
first and second capillary tube end portions extending from outside of the probe body into the hollow core of the probe body, the first capillary tube end portion terminating closer than the second capillary tube end portion to an internal face of the sintered element; and
wherein the hollow core of the probe body has a volume of less than 5 cm³, less than 4 cm³, less than 3 cm³, less than 2 cm³, less than 1 cm³, less than 0.5 cm³, or even less than 0.3 cm³.

In some embodiments, the hollow core of the soil gas sampling probe has a volume of at least 0.2 cm³, or even at least 0.25 cm³.

Embodiment 2. The soil gas sampling probe of embodiment 1, wherein the first and second capillary tube end portions each have an inside diameter of less than 2 micrometers, less than 1 micrometer, or even less than 0.8 micrometer. In some embodiments, the capillary tubing is stainless steel.

Embodiment 3. The soil gas sampling probe of any of embodiments 1 to 2, wherein the sintered element has a pore size in a range of from 2 micrometers to 40 micrometers, from 2 micrometers to 20 micrometers, from or even from 5 micrometers to 15 micrometers. In some embodiments, the sintered element has a pore size of about 10 micrometers.

In some embodiments, the sintered element is a disc having a diameter in a range of 5 mm to 250 mm, from 5 mm to 200 mm, from 5 mm to 100 mm, from 5 mm to 50 mm, from 5 mm to 20 mm, or even from 5 mm to 10 mm. In an embodiment, the sintered element has a diameter of about 6 mm.

Embodiment 4. The soil gas sampling probe of any of embodiments 1 to 3, wherein the probe body is a hollow cylinder having an overall length in a range of from 15 mm to 50 mm, from 20 mm to 40 mm, or even from 20 mm to 30 mm.

Embodiment 5. The soil gas sampling probe of any of embodiments 1 to 4, wherein the sintered element having a diameter in a range of from 5 mm to 250 mm, from 5 mm to 200 mm, from 5 mm to 100 mm, from 5 mm to 50 mm, from 5 mm to 20 mm, or even from 5 mm to 10 mm. In an embodiment, the sintered element has a diameter of about 6 mm.

Embodiment 6. The soil gas sampling probe of any of embodiments 1 to 5, wherein the sintered element comprises a hydrophobic coating.

Embodiment 7. The soil gas sampling probe of any of embodiments 1 to 6, wherein the probe body comprises borosilicate glass.

Embodiment 8. The soil gas sampling probe of any of embodiments 1 to 7, wherein an adhesive is disposed between the probe body and the sintered material. In some embodiments, the adhesive is an epoxy adhesive.

Embodiment 9. The soil gas sampling probe of any of embodiments 1 to 8, further comprising a microsensor disposed on an interior surface of the probe body. In some embodiments, the microsensor is a pressure microsensor, a humidity microsensor, or a temperature microsensor.

Embodiment 10. The soil gas sampling probe of any of embodiments 1 to 9, wherein the microsensor is a pressure microsensor.

Embodiment 11. A soil gas sampling system, comprising:
at least one soil gas sampling probe according to any of embodiments 1 to 10;
a recirculation loop of elements connected in series, the elements including the gas sampling probe, a volume expansion tube, a micropump, and a flow-through valve;
wherein the recirculation loop of elements begins and ends at the gas sampling probe;
and
wherein the elements in the recirculation loop are connected via tubing.

Embodiment 12. The soil gas sampling system of embodiment 11, further comprising an analytical device connected to the flow-through valve.

Embodiment 13. The soil gas sampling system of any of embodiments 11 to 12, wherein the analytical device is a gas chromatograph.

Embodiment 14. The soil gas sampling system of any of embodiments 11 to 13, comprising a plurality of recirculation loops, wherein the flow-through valve is a multichannel flow-through valve that is shared among the plurality of recirculation loops, and wherein each loop in the plurality of recirculation loops includes a soil gas sampling probe.

Embodiment 15. The soil gas sampling system of any of embodiments 11 to 14, further comprising microprocessor control of the flow-through valve.

Embodiment 16. The soil gas sampling system of any of embodiments 11 to 15, wherein the micropump is a low-fluctuation micropump.

Embodiment 17. The soil gas sampling system of any of embodiments 11 to 16, further comprising a gas detection calibration system.

Embodiment 18. A method of measuring soil gas, comprising:
a) exposing a soil gas sampling probe in the soil gas sampling system of any of embodiments 1 to 10 to a soil sample;
b) activating the micropump in the soil gas sampling system;
c) allowing time for a sample of soil gas to diffuse from the soil into the soil gas sampling probe; and
d) analyzing the sample of soil gas.

In some embodiments, the method of measuring a gas further comprises allowing time (for example, 15 minutes to 90 minutes) for the sample of soil gas to recirculate through the recirculation loop, thereby equilibrating the soil gas throughout the components of the recirculation loop, including the volume expansion tube.

Embodiment 19. The method of embodiment 18, wherein analyzing the sample of soil gas comprises diverting a portion of the sample of soil gas to a gas chromatograph.

Embodiment 20. The method of any of embodiments 18 to 19, wherein multiple soil gas sampling probes are connected to the soil gas sampling system.

Embodiment 21. The soil gas probes consist of a small borosilicate glass tube (e.g., 2.5 cm long; 0.625 diameter; internal volume 0.25 mL) adhered to a membrane disk (˜0.3 cm² surface area)(such as sintered stainless-steel (SS; 10 uM; Porous Materials)) across which molecules diffusively exchange between the soil gas and probe from a specific, small point in soil. For enhanced hydrophobicity, to allow gas exchange but prevent soil water intrusion into the probe, the SS probe membranes may be coated by chemical vapor deposition of inert coatings (e.g., Dursan SiloTek). Each soil gas probe may be connected to an individual recirculating loop tubing connected with epoxy to the far end of the soil probe ( 1/16″ SS via inlet and outlet tubing). The recirculating loops may include a micropump (e.g., 2.5 mL/min; MP-6 gas, Bartels Microteknik, Germany) to drive the internal gas recirculation, an expansion volume (e.g., glass tubing) to create enough equilibrated soil gas for to transfer for measurement, and passage through a multiport selecting flow-through valve (e.g., VICI Valco STF) that allows sample gas to simply continue to flow around the recirculating loop until analysis. Additional sensors may be embedded within the probe, for example, a pressure microsensor can be inserted to ensure that no pressure gradients form that drive advective flow across the probe membrane, to ensure that soil gases are sampled by non-disruptive molecular diffusion. To measure the diffusively equilibrated soil gas sample, a probe may be selected by the multiport valve and the gas sample is directed (by the micropump) through the recirculating loop to the gas analyzer for quantification. The probe of the present invention may be used to measure the concentration of any gas in a soil gas sample, when the soil gas sampling system includes a suitable detector. For example, the concentration of molecular hydrogen (H₂) in soil gas can be measured via gas chromatography (GC; e.g., Reducing Gas Detector, Peak Laboratories) using a sample loop (e.g., 50 uL sample loop) with controlled transfer of the soil gas sample through a stream selection valve (e.g., VICI) and mass flow controller (e.g., Alicat). In further embodiments, transferred soil gas may be replaced by averaged room air, but other inert gases could be used instead.

Embodiment 22. The soil gas sampling probe of embodiment 1, wherein said probe is made a material that is inert to the gases being tested (and is optionally resistant to breakage).

### LITERATURE REFERENCES

Gil-Loaiza (2020): Gil-Loaiza et al., Versatile soil gas concentration and isotope monitoring: optimization and integration of novel soil gas probes with online trace gas detection”, preprint in Biogeosciense discussions, obtained from https://bg.copernicus.org/preprints/bg-2020-401/bg-2020-401.pdf (retrieved May 6, 2021).
Piché-Choquette (2018): Sarah Piché-Choquette et al., “Dose-response relationships between environmentally-relevant H₂ concentrations and the biological sinks of H₂, CH₄ and CO in soil. Soil Biology and Biochemistry. 123. 10.1016/j.soilbio.2018.05.008.”
Masoom (2016): Hussain Masoom et al., “Soil Organic Matter in Its Native State: Unravelling the Most Complex Biomaterial on Earth” Environmental Science and Technology, 50. 10.. 1021/acs.est.5b03410. https://www.researchgate.net/publication/291328201_Soil_Organic_Matter_in_Its_Native_St ate_Unravelling_the_Most_Complex_Biomaterial_on_Earth (retrieved May 7, 2021)
Allison, G. B., C. Colin-Kaczala, A. Filly, and J. C. H. Fontes. 1987. “Measurement of Isotopic Equilibrium between Water, Water Vapour and Soil CO2 in Arid Zone Soils.” Journal of Hydrology 95 (1): 131-41.
Bass, Adrian M., Michael I. Bird, Marshall J. Morrison, and Jeremy Gordon. 2012. “CADICA: Continuous Automated Dissolved Inorganic Carbon Analyzer with Application to Aquatic Carbon Cycle Science.” Limnology and Oceanography, Methods/ASLO 10 (1): 10-19.
Burton, D. L., and E. G. Beauchamp. 1994. “Profile Nitrous Oxide and Carbon Dioxide Concentrations in a Soil Subject to Freezing.” Published in Soil Sci. Soc. Am. J. 58: 115-22.
Cates, R. L., Jr., and D. R. Keeney. 1987. “Nitrous Oxide Production throughout the Year from Fertilized and Manured Maize Fields.” Journal of Environmental Quality 16 (4): 443-47.
Davidson, Eric A., and Susan E. Trumbore. 1995. “Gas Diffusivity and Production of CO2 in Deep Soils of the Eastern Amazon.” Tellus. Series B, Chemical and Physical Meteorology 47 (5): 550-65.
De Gregorio, S., S. Gurrieri, and M. Valenza. 2005. “A PTFE Membrane for the in Situ Extraction of Dissolved Gases in Natural Waters: Theory and Applications.” Geochemistry, Geophysics, Geosystems 6 (9). https://agupubs.onlinelibrary.wiley.com/doi/abs/10.1029/2005GC000947.
Demand, Dominic, Helmer Schack-Kirchner, and Friederike Lang. 2017. “Assessment of Diffusive Phosphate Supply in Soils by Microdialysis.” Journal of Plant Nutrition and Soil Science. https://doi.org/10.1002/jpln.201600412.
DeSutter, Thomas M., Thomas J. Sauer, and Timothy B. Parkin. 2006. “Porous Tubing for Use in Monitoring Soil CO2 Concentrations.” Soil Biology & Biochemistry 38 (9): 2676-81.
Dowdell, R. J., K. A. Smith, Rachel Crees, and S. W. F. Restall. 1972. “Field Studies of Ethylene in the Soil Atmosphere-Equipment and Preliminary Results.” Soil Biology & Biochemistry 4 (3): 325-31.
Fang, C., and J. B. Moncrieff. 1998. “Simple and Fast Technique to Measure CO2 Profiles in Soil.” Soil Biology and Biochemistry. https://doi.org/10.1016/s0038-0717(98)00088-1.
Gaj, Marcel, Matthias Beyer, Paul Koeniger, Heike Wanke, Josefina Hamutoko, and Thomas Himmelsbach. 2016. “In Situ Unsaturated Zone Water Stable Isotope (2H and 180) Measurements in Semi-Arid Environments: A Soil Water Balance.” Hydrology and Earth System Sciences 20 (2): 715-31.
Gangi, Laura, Youri Rothfuss, Jerôme Ogée, Lisa Wingate, Harry Vereecken, and Nicolas Brüggemann. 2015. “A New Method for In Situ Measurements of Oxygen Isotopologues of Soil Water and Carbon Dioxide with High Time Resolution.” Vadose Zone Journal 14. https://doi.org/10.2136/vzj2014.11.0169.
Gut, A. 2002. “NO Emission from an Amazonian Rain Forest Soil: Continuous Measurements of NO Flux and Soil Concentration.” Journal of Geophysical Research. https://doi.org/10.1029/2001jd000521.
Gut, A., A. Blatter, M. Fahrni, B. E. Lehmann, A. Neftel, and T. Staffelbach. 1998. “A New Membrane Tube Technique (METT) for Continuous Gas Measurements in Soils.” Plant and Soil 198 (1): 79-88.
Hack, H. R. B. 1956. “AN APPLICATION OF A METHOD OF GAS MICROANALYSIS TO THE STUDY OF SOIL AIR.” Soil Science 82 (3): 217.
Haren, Joost L. M. van, Linda L. Handley, Karl Y. Biel, Valery N. Kudeyarov, Jean E. T. McLain, Dean A. Martens, and Debra C. Colodner. 2005. “Drought-Induced Nitrous Oxide Flux Dynamics in an Enclosed Tropical Forest.” Global Change Biology 11 (8): 1247-57.
Herbstritt, Barbara, Benjamin Gralher, and Markus Weiler. 2012. “Continuous in Situ Measurements of Stable Isotopes in Liquid Water.” Water Resources Research 48 (3). https://agupubs.onlinelibrary.wiley.com/doi/abs/10.1029/2011wr011369.
Hirano, Takashi, Honghyun Kim, and Yumiko Tanaka. 2003. “Long-Term Half-Hourly Measurement of Soil CO2 Concentration and Soil Respiration in a Temperate Deciduous Forest.” Journal of Geophysical Research, D: Atmospheres 108 (D20). https://agupubs.onlinelibrary.wiley.com/doi/abs/10.1029/2003JD003766.
Hirsch, Adam I., Susan E. : Trumbore, and Michael L. Goulden. 2004. “The Surface CO2 Gradient and Pore-Space Storage Flux in a High-Porosity Litter Layer.” Tellus B: Chemical and Physical Meteorology. https://doi.org/10.3402/tellusb.v5614.16449.
Holter, Peter. 1990. “Sampling Air from Dung Pats by Silicone Rubber Diffusion Chambers.” Soil Biology & Biochemistry 22 (7): 995-97.
Jacinthe, P-A, and W. A. Dick. 1996. “Use of Silicone Tubing to Sample Nitrous Oxide in the Soil Atmosphere.” Soil Biology & Biochemistry 28 (6): 721-26.
Jassal, Rachhpal, Andy Black, Mike Novak, Kai Morgenstern, Zoran Nesic, and David Gaumont-Guay. 2005. “Relationship between Soil CO2 Concentrations and Forest-Floor CO2 Effluxes.” Agricultural and Forest Meteorology 130 (3): 176-92.
Johnson, Mark S., Michael F. Billett, Kerry J. Dinsmore, Marcus Wallin, Kirstie E. Dyson, and Rachhpal S. Jassal. 2010. “Direct and Continuous Measurement of Dissolved Carbon Dioxide in Freshwater Aquatic Systems-method and Applications.” Ecohydrology: Ecosystems, Land and Water Process Interactions, Ecohydrogeomorphology 3 (1): 68-78.
Jong, E. D. E., and H. J. V. Schappert. 1972. “CALCULATION OF SOIL RESPIRATION AND ACTIVITY FROM CO2 PROFILES IN THE SOIL.” Soil Science 113 (5): 328.
Kammann, C., L. Grünhage, and H. -J. Jäger. 2001. “A New Sampling Technique to Monitor Concentrations of CH₄, N20 and CO2in Air at Well-Defined Depths in Soils with Varied Water Potential.” European Journal of Soil Science. https://doi.org/10.1046/j.1365-2389.2001.00380.x.
Koelling, Martin, Henrik Hecht, and Gerhard A. Holst. 2002. “Simple Plastic Fiber-Based Optode Array for the in-Situ Measurement of Ground Air Oxygen Concentrations.” In Advanced Environmental Sensing Technology II, 4576:75-86. International Society for Optics and Photonics.
Kokic, Jovana, Marcus B. Wallin, Hannah E. Chmiel, Blaize A. Denfeld, and Sebastian Sobek. 2015. “Carbon Dioxide Evasion from Headwater Systems Strongly Contributes to the Total Export of Carbon from a Small Boreal Lake Catchment.” Journal of Geophysical Research: Biogeosciences 120 (1): 13-28.
Krämer, Heribert, and Ralf Conrad. 1993. “Measurement of Dissolved H₂ Concentrations in Methanogenic Environments with a Gas Diffusion Probe.” FEMS Microbiology Ecology 12 (3): 149-58.
Laemmel, T., M. Maier, H. Schack-Kirchner, and F. Lang. 2017. “Anin Situmethod for Real-Time Measurement of Gas Transport in Soil: Monitoring of Gas Transport in Soil.” European Journal of Soil Science 68 (2): 156-66.
Leith, F. I., K. J. Dinsmore, M. B. Wallin, M. F. Billett, K. V. Heal, H. Laudon, M. G. Öquist, and K. Bishop. 2015. “Carbon Dioxide Transport across the Hillslope-riparian-stream Continuum in a Boreal Headwater Catchment.” Biogeosciences. https://doi.org/10.5194/bg-12-1881-2015.
MacDonald, Luke H., Jeffery S. Paull, and Peter R. Jaffé. 2013. “Enhanced Semipermanent Dialysis Samplers for Long-Term Environmental Monitoring in Saturated Sediments.” Environmental Monitoring and Assessment 185 (5): 3613-24.
Maljanen, M., A. Liikanen, J. Silvola, and P. J. Martikainen. 2003. “Measuring N20 Emissions from Organic Soils by Closed Chamber or Soil/snow N20 Gradient Methods.” European Journal of Soil Science 54 (3): 625-31.
Mckay Fletcher, D. M., R. Shaw, A. R. Sánchez-Rodriguez, K. R. Daly, A. van Veelen, D. L. Jones, and T. Roose. 2019. “Quantifying Citrate-Enhanced Phosphate Root Uptake Using Microdialysis.” Plant and Soil, December. https://doi.org/10.1007/s11104-019-04376-4.
Munksgaard, N. C., C. M. Wurster, A. Bass, and M. I. Bird. 2012. “Extreme Short-Term Stable Isotope Variability Revealed by Continuous Rainwater Analysis.” Hydrological Processes. https://doi.org/10.1002/hyp.9505.
Munksgaard, N. C., C. M. Wurster, A. Bass, I. Zagorskis, and M. I. Bird. 2012. “First Continuous Shipboard δ18O and δD Measurements in Sea Water by Diffusion Sampling-cavity Ring-down Spectrometry.” Environmental Chemistry Letters 10 (3): 301-7.
Munksgaard, Niels C., Chris M. Wurster, and Michael I. Bird. 2011. “Continuous Analysis of δ18O and δD Values of Water by Diffusion Sampling Cavity Ring-down Spectrometry: A Novel Sampling Device for Unattended Field Monitoring of Precipitation,
Ground and Surface Waters.” Rapid Communications in Mass Spectrometry. https://doi.org/10.1002/rcm.5282.
Parkin, Timothy B., and James M. Tiedje. 1984. “Application of a Soil Core Method to Investigate the Effect of Oxygen Concentration on Denitrification.” Soil Biology & Biochemistry 16 (4): 331-34.
Risk, David, Lisa Kellman, and Hugo Beltrami. 2002. “Carbon Dioxide in Soil Profiles: Production and Temperature Dependence.” Geophysical Research Letters 29 (6): 11-11.
Rothfuss, Franz, and Ralf Conrad. 1994. “Development of a Gas Diffusion Probe for the Determination of Methane Concentrations and Diffusion Characteristics in Flooded Paddy Soil.” FEMS Microbiology Ecology 14 (4): 307-18.
Rothfuss, Youri, Harry Vereecken, and Nicolas Brüggemann. 2013. “Monitoring Water Stable Isotopic Composition in Soils Using Gas-Permeable Tubing and Infrared Laser Absorption Spectroscopy.” Water Resources Research. https://doi.org/10.1002/wrcr.20311.
Roulier, M. H., L. H. Stolzy, and T. E. Szuszkiewcz. 1974. “An Improved Procedure for Sampling the Atmosphere of Field Soils.” Soil Science Society of America Journal. Soil Science Society of America 38 (4): 687-89.
Smith-Downey, Nicole V., James T. Randerson, and John M. Eiler. 2008. “Molecular Hydrogen Uptake by Soils in Forest, Desert, and Marsh Ecosystems in California.” Journal of Geophysical Research: Biogeosciences 113 (G3). https://agupubs.onlinelibrary.wiley.com/doi/abs/10.1029/2008JG000701.
Sotomayor, David, and Charles W. Rice. 1999. “Soil Air Carbon Dioxide and Nitrous Oxide Concentrations in Profiles under Tallgrass Prairie and Cultivation.” Journal of Environmental Quality 28: 784-93.
Tackett, J. L. 1968. “Theory and Application of Gas Chromatography in Soil Aeration Research.” Soil Science Society of America Journal. Soil Science Society of America 32 (3): 346-50.
Tang, Jianwu, Dennis D. Baldocchi, Ye Qi, and Liukang Xu. 2003. “Assessing Soil CO2 Efflux Using Continuous Measurements of CO2 Profiles in Soils with Small Solid-State Sensors.” Agricultural and Forest Meteorology 118 (3): 207-20.
Taylor, George S., and J. H. Abrahams. 1953. “A Diffusion-Equilibrium Method for Obtaining Soil Gases under Field Conditions.” Soil Science Society of America Journal. Soil Science Society of America 17 (3): 201-6.
Thoma, G., N. Esser, C. Sonntag, W. Weiss, J. Rudolph, and P. Leveque. 1979. “New Technique of in-Situ Soil-Moisture Sampling for Environmental Isotope Analysis Applied at Pilat Sand Dune near Bordeaux. HETP Modelling of Bomb Tritium Propagation in the Unsaturated and Saturated Zones.” In Isotope Hydrology 1978.
Thompson, Glenn M., and Donn L. Marrin. 1987. “Soil Gas Contaminant Investigations: A Dynamic Approach.” Groundwater Monitoring & Remediation. https://doi.org/10.1111/j.1745-6592.1987.tb01079.x.
Van Bavel, C. H. M. 1965. “Composition of Soil Atmosphere.” Methods of Soil Analysis: Part 1 Physical and Mineralogical Properties, Including Statistics of Measurement and Sampling 9: 315-18.
Volkmann, T. H. M., and M. Weiler. 2014. “Continual in Situ Monitoring of Pore Water Stable Isotopes in the Subsurface.” Hydrology and Earth System Sciences 18 (5): 1819-33.
Volkmann, Till H. M., Kristine Haberer, Arthur Gessler, and Markus Weiler. 2016. “High-Resolution Isotope Measurements Resolve Rapid Ecohydrological Dynamics at the Soil-Plant Interface.” The New Phytologist 210 (3): 839-49.
Volkmann, Till H. M., Kathrin Kühnhammer, Barbara Herbstritt, Arthur Gessler, and Markus Weiler. 2016. “A Method for in Situ Monitoring of the Isotope Composition of Tree Xylem Water Using Laser Spectroscopy.” Plant, Cell & Environment 39 (9): 2055-63.
Volkmann, Till H. M., Aditi Sengupta, Luke A. Pangle, Katerina Dontsova, Greg A. Barron-Gafford, Ciaran J. Harman, Guo-Yue Niu, et al. 2018. “Controlled Experiments of Hillslope Coevolution at the Biosphere 2 Landscape Evolution Observatory: Toward Prediction of Coupled Hydrological, Biogeochemical, and Ecological Change.” In Hydrology of Artificial and Controlled Experiments.

We claim:

1. A soil gas sampling probe, comprising:
an elongated probe body defining a hollow core and an open end;
a sintered element disposed at the open end of the probe body;
first and second capillary tube end portions extending from outside of the probe body into the hollow core of the probe body, the first capillary tube end portion terminating closer than the second capillary tube end portion to an internal face of the sintered element; and
wherein the hollow core of the probe body has a volume of less than 5 cm³.

2. The soil gas sampling probe of claim 1, wherein the first and second capillary tube end portions each have an inside diameter of less than 2 mm.

3. The soil gas sampling probe of claim 1, wherein the sintered element has a pore size in a range of from 2 micrometers to 40 micrometers.

4. The soil gas sampling probe of claim 1, wherein the probe body is a hollow cylinder having an overall length in a range of from 20 mm to 50 mm.

5. The soil gas sampling probe of claim 1, wherein the sintered element is a disc having a diameter in a range of from 5 mm to 250 mm.

6. The soil gas sampling probe of claim 1, wherein the sintered element comprises a hydrophobic coating.

7. The soil gas sampling probe of claim 1, wherein the probe body comprises glass (e.g., borosilicate glass).

8. The soil gas sampling probe of claim 1, wherein an adhesive is disposed between the probe body and the sintered material (e.g., sintered stainless steel).

9. The soil gas sampling probe of claim 1, further comprising a microsensor disposed on an interior surface of the probe body.

10. The soil gas sampling probe of claim 9, wherein the microsensor is a pressure microsensor.

11. A soil gas sampling system, comprising:
at least one soil gas sampling probe according to claim 1;
a recirculation loop of elements connected in series, the elements including the gas sampling probe, a volume expansion tube, a micropump, and a flow-through valve;
wherein the recirculation loop of elements begins and ends at the gas sampling probe; and
wherein the elements in the recirculation loop are connected via tubing.

12. The soil gas sampling system of claim 11, further comprising an analytical device connected to the flow-through valve.

13. The soil gas sampling system of claim 11, wherein the analytical device is a gas chromatograph.

14. The soil gas sampling system of claim 11, comprising a plurality of recirculation loops, wherein the flow-through valve is a multichannel flow-through valve that is shared among the plurality of recirculation loops, and wherein each loop in the plurality of recirculation loops includes a soil gas sampling probe.

15. The soil gas sampling system of claim 11, further comprising microprocessor control of the flow-through valve.

16. The soil gas sampling system of claim 11, wherein the micropump is a low-fluctuation micropump.

17. The soil gas sampling system of claim 11, further comprising a gas detection calibration system.

18. A method of measuring soil gas, comprising:
a) exposing a soil gas sampling probe in the soil gas sampling system of claim 11 to a soil sample;
b) activating the micropump in the soil gas sampling system;
c) allowing time for a sample of soil gas to diffuse from the soil into the soil gas sampling probe; and
d) analyzing the sample of soil gas.

19. The method of claim 18, wherein analyzing the sample of soil gas comprises diverting a portion of the sample of soil gas to a gas chromatograph.

20. The method of claim 18, wherein multiple soil gas sampling probes are connected to the soil gas sampling system.
